(19) United States
(12) Patent Application Publication
(10) Pub. No.: US 2007/0183337 A1
(43) Pub. Date: Aug. 9, 2007

(54) FC-AL cabling management system

(75) Inventors: Paul N. Cashman, Alton (GB); John C. Elliott, Tucson, AZ (US); Robert A. Kubo, Tucson, AZ (US); Gregg S. Lucas, Tucson, AZ (US)

Correspondence Address: QUARLES & BRADY LLP, 1 SOUTH CHURCH AVENUE, SUITE 1700, TUCSON, AZ, 85701, US

(73) Assignee: International Business Machines Corporation, Armonk, NY (US)

(21) Appl. No.: 11/347,439

(22) Filed: Feb. 3, 2006

(51) Int. Cl. H04J 1/16

(52) U.S. Cl. 370/250

(57) ABSTRACT

An apparatus to detect a fiber channel miscabling event includes a module configured to identify a connection made between first and second unlike devices in a fiber channel topology. If an unlike connection identified to have been made the module enables an upstream port of the second device, leaving a downstream port of the second device disabled. A method to detect a fiber channel miscabling event includes detecting a fiber channel cable connection configuration, determining whether a connection is made between first and second unlike fiber channel units, and enabling an upstream port of the second fiber channel unit while keeping a downstream port of the second fiber channel unit disabled if an unlike connection is determined to have been made.

### BACKGROUND OF THE INVENTION

1. Field of the Invention

The present invention relates in general to fibre channel arbitrated loop networks and more particularly relates to detecting a fibre channel miscabling event.

2. Description of the Prior Art

Recent technical developments have created a need for extremely fast data links. High performance computing devices and data connections have become the focus of much attention in the data communications industry. Performance improvements have resulted in increasingly data-intensive and high-speed networking applications. However, the existing network interconnects between computers and I/O devices are unable to run at the speeds needed to satisfy the increased need for data handling.

Typically, data communication connections are configured as either channels or networks. A channel provides a direct or switched point-to-point connection between the communicating nodes. A channel is typically hardware-intensive and communicates data at high speeds with low resource overhead. A network configuration is an aggregation of distributed nodes with a protocol that controls interactions among the nodes. A network is software-intensive, and consequently has a relatively high resource overhead. Although networks are capable of handing a wider variety of communication tasks than channels, the high resource overhead greatly reduces data transmission rates.

One recent solution to this increasing demand for data handling capability is Fibre Channel (FC). FC has been developed to provide a practical, inexpensive, and readily expandable mode of transferring data at extremely high rates between workstations, mainframes, supercomputers, storage devices, and other peripheral computing devices. FC combines the use of high performance hardware with versatile software for a hybrid channel-network communication mode.

One common environment wherein FC connections are utilized is a data storage environment. For example, an application server may interface with several data storage devices. The application server may require high data rate access to remotely located modular data storage devices in order to store large amounts of application transaction data. A channel configuration is desirable in order to achieve the required high data rates. However, the versatility of a network configuration is beneficial when working with remote devices. In such an example, an FC connection is optimal, because it provides extremely high data rates while achieving greater versatility than common channel connections.

The remote storage devices may be connected in a modular configuration. Each module may contain multiple FC ports to allow access to the storage device. In some instances, an FC fabric is capable of supporting 127 or more FC ports. In such instances, miscabling is a common problem. With a large number of FC connections between multiple storage devices located at remote sites, the task of cabling can be a confusing and an often error prone task.

In one example, an Automatic Teller Machine (ATM) may need to make extremely high speed data transactions with multiple data storage devices located remotely at a bank. In such an example, data storage reliability is crucial because errors may be extremely costly. If one of the cable connections is inadvertently cross connected, the data may be corrupted, or processing the transaction may not be possible at all. Typically, such cabling errors are extremely difficult to detect.

From the foregoing discussion, it should be apparent that a need exists for an apparatus, system, and method that detect a fibre channel miscabling event. Beneficially, such an apparatus, system, and method would afford the benefits of versatility and speed associated with implementation of FC systems, while providing reliability and easy troubleshooting in the case of a cabling error.

### SUMMARY OF THE INVENTION

The present invention has been developed in response to the present state of the art, and, in particular, in response to the problems and needs in the art that have not yet been fully solved by currently available fibre channel data communication configurations. Accordingly, the present invention has been developed to provide an apparatus, system, and method for detecting a fibre channel miscabling event that overcome many or all of the above-discussed shortcomings in the art.

The apparatus to detect a fibre channel miscabling event is provided with a logic unit containing a plurality of modules configured to functionally execute the necessary steps of detecting a fibre channel cable connection configuration, determining whether the connection configuration is valid according to preset validity requirements, and enabling a valid fibre channel connection. These modules in the described embodiments include a detect module, a determine module, and an enable module.

In one embodiment, the detect module is configured to detect a fibre channel cable connection configuration. The detect module may additionally include modules required to carry out the steps of synchronizing a clock signal, synchronizing a word transmission, and communicating a unique port identifier. These modules may include a clock synchronization module, a word synchronization module, and a communication module. In one embodiment, the unique port identifier includes an enclosure identifier, a card identifier, and a port identifier.

In one embodiment, the determine module determines whether the connection configuration is valid according to preset validity requirements. In an additional embodiment, the apparatus includes a set module configured to set validity requirements for allowable connection configurations. The apparatus may additionally include a bypass module configured to bypass the fibre channel connection until the fibre channel connection is determined valid and enabled.

In one embodiment, the enable module is configured to enable a valid fibre channel connection. An invalid fibre channel connection may trigger an error module to indicate an error. Additionally, a storing module may store error information when a connection configuration is determined invalid.

In an alternative embodiment, the apparatus may include modules necessary to carry out the steps of detecting a fibre channel cable connection, communicating a unique port identifier, and receiving data on an enabled fibre channel connection. These modules may include a detect module, a communication module, and a receive module.

A system of the present invention is also presented to detect a fibre channel miscabling event. In one embodiment, the system includes a first fibre channel unit configured to detect a fibre channel cable connection configuration, determine whether the connection configuration is valid according to preset validity requirements, and enable a valid fibre channel connection; and a second fibre channel unit configured to detect a fibre channel cable connection, communicate a unique port identifier, and receive data on an enabled fibre channel connection.

A method of the present invention is also presented for detecting a fibre channel miscabling event. The method in the disclosed embodiments substantially includes the steps necessary to carry out the functions presented above with respect to the operation of the described apparatus and system. Additionally, a method for providing a service to carry out the functions presented above is presented.

In another embodiment, an apparatus to detect a fibre channel miscabling event includes a module configured to identify a connection made between first and second unlike devices in a fibre channel topology, wherein if an unlike connection is made the module enables an upstream port of the second device, leaving a downstream port of the second device disabled.

In another embodiment, a signal bearing medium tangibly embodying a program of machine-readable instructions executable by a digital processing apparatus to perform operations to detect a fibre channel miscabling event is disclosed, the operations comprising detecting a fibre channel cable connection configuration, determining whether a connection is made between first and second unlike fibre channel units and enabling an upstream port of the second fibre channel unit while keeping a downstream port of the second fibre channel unit disabled if an unlike connection is determined to have been made.

In still another embodiment, a method to detect a fibre channel miscabling event includes detecting a fibre channel cable connection configuration, determining whether a connection is made between first and second unlike fibre channel units and enabling an upstream port of the second fibre channel unit while keeping a downstream port of the second fibre channel unit disabled if an unlike connection is determined to have been made.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a system for detecting a fibre channel miscabling event.

FIG. 2 is a schematic block diagram illustrating one embodiment of an apparatus for detecting a fibre channel miscabling event.

FIG. 3 is a detailed schematic block diagram illustrating one embodiment of an apparatus for detecting a fibre channel miscabling event.

FIG. 4 is a schematic block diagram illustrating an alternative embodiment of an apparatus for detecting a fibre channel miscabling event.

FIG. 5 is a schematic flow chart diagram illustrating one embodiment of a method for detecting a fibre channel miscabling event.

FIG. 6 is a detailed schematic flow chart diagram illustrating one embodiment of a method for detecting a fibre channel miscabling event.

FIG. 7 is a detailed schematic block diagram illustrating one example of a valid fibre channel cable connection configuration.

FIG. 8 is a detailed schematic block diagram illustrating another example of a valid fibre channel cable connection configuration including properly cascaded enclosures between like devices.

FIG. 9 is a detailed schematic block diagram illustrating an example of an improperly connected fibre channel cable connection configuration.

FIG. 10 is a schematic flow chart diagram illustrating another embodiment of a method for detecting a fibre channel miscabling event.

### DETAILED DESCRIPTION OF THE DRAWINGS

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a signal bearing medium may take any form capable of generating a signal, causing a signal to be generated, or causing execution of a program of machine-readable instructions on a digital processing apparatus. A signal bearing medium may be embodied by a transmission line, a compact disk, digital-video disk, a magnetic tape, a Bernoulli drive, a magnetic disk, a punch card, flash memory, integrated circuits, or other digital processing apparatus memory device.

Reference to service may include any conceivable service offering associated with analysis, design, implementation, or utilization of the disclosed apparatus, system, or method. A service may additionally include but is not limited to rental, lease, licensing, and other offering, contractual or otherwise, of hardware, software, firmware, network resources, data storage resources, physical facilities, and the like. Services may additionally include physical labor, consulting, and other offerings of physical, intellectual, and human resources.

The schematic flow chart diagrams included are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

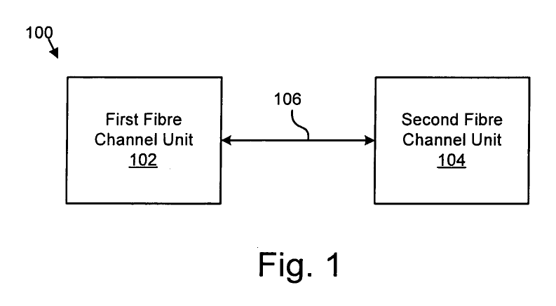

FIG. 1 illustrates one embodiment of a system 100 for detecting a fibre channel miscabling event. In one embodiment, the system 100 includes a first fibre channel unit 102 and a second fibre channel unit 104. Additionally, the system 100 may include one or more fibre channel cable connections 106.

In one embodiment, the first fibre channel unit 102 is configured to detect a fibre channel cable connection 106 configuration, determine whether the connection 106 configuration is valid according to preset validity requirements, and enable a valid fibre channel connection 106. The first fibre channel unit 102 may include an enclosure, one or more fibre channel control cards, one or more fibre channel ports, and a local processor.

In one embodiment, the second fibre channel unit 104 is configured to detect a fibre channel cable connection, communicate a unique port identifier, and receive data on an enabled fibre channel connection. The second fibre channel unit 104 may also include an enclosure, one or more fibre channel control cards, one or more fibre channel ports, and a local processor.

The first fibre channel unit 102 and the second fibre channel unit 104 may provide a high speed data communication interface to one or more data storage devices, servers, mainframes, and other peripheral computing and data communication devices. One example of a system 100 employing fibre channel data interfaces is a data storage system. An application server may connect via a fibre channel interface to multiple fibre channel units 102, 104. The fibre channel units 102, 104 may be connected via one or more fibre channel connection 106. In such an example, data from the application server may be stored on any one of the storage devices with an enabled fibre channel connection 106. In this example, the application server has a highly reliable and relatively high rate data communication connection 106 to the storage devices with the fibre channel unit 102, 104 interfaces.

Many configurations of connection 106 configurations may exist between the first fibre channel unit 102 and the second fibre channel unit 104. Multiple fibre channel units 102, 104 may be arranged in a cascaded, chained, peer-to-peer, cross-point switched, or looped configuration. Arbitrated loop is one commonly implemented fibre channel configuration, wherein the disclosed apparatus system and method may be successfully utilized.

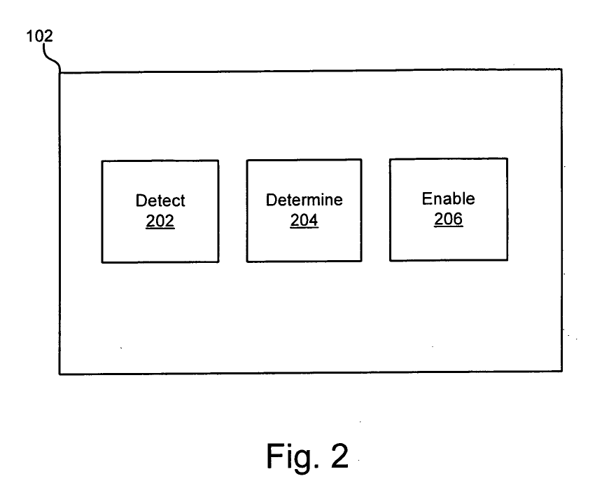

FIG. 2 illustrates one embodiment of an apparatus 102 for detecting a fibre channel miscabling event. In one embodiment, the apparatus 102 is the first fibre channel unit 102. The apparatus 102 may include a detect module 202, a determine module 204, and an enable module 206.

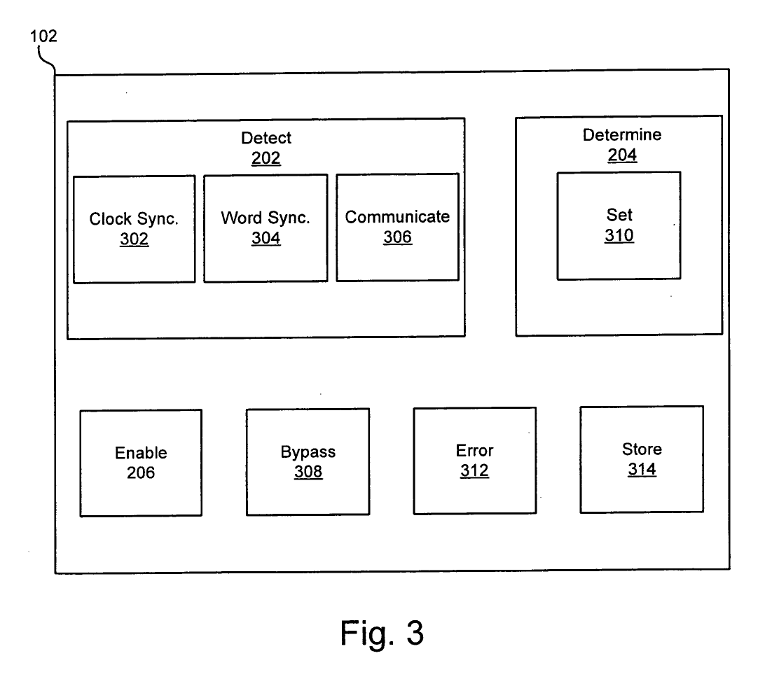

In one embodiment, the detect module 202 is configured to detect a fibre channel connection configuration. For example, the detect module 202 may include a fibre channel switch that performs a topology exploration to discover whether or not a compatible device is connected to the ports thereof. If compatible devices are detected, a bi-directional data transfer occurs between the two switch devices. Additional detailed embodiments of such a bi-directional data transfer are described further with relation to FIG. 3.

In one embodiment, the determine module 204 determines whether the connection configuration is valid according to preset validity requirements. For example, the determination module may be a firmware process that runs on a local processor located on the apparatus 102. The determine module 204 may check information collected by the detect module 202 against preset validation requirements to determine the validity of the connection. In one embodiment, the validation requirements may primarily define acceptable physical port connections.

In one embodiment, the enable module 206 enables a valid fibre channel connection 106. Enabling the connection will incorporate the data port in question into a fibre channel data communication network. Once enabled, the connection 106 may be used to store data, retrieve data, make application transactions, and the like.

The apparatus may continue to monitor the ports for changes to the initial connection configuration. For example, if the system is cabled correctly upon initialization, and the connections are enabled by the enable module 206, cabling errors may still arise from loose cable connections, user error, accidental disconnection of the cables and the like. If such a situation arises, the detect module 202 will detect that the connection has been reestablished and start a new connection configuration detection process. Connection is bypassed until the determine module 204 determines that the connection is valid. When the determine module 204 determines that the connection is valid, the enable module 206 enables the connection again for data communication.

FIG. 3 illustrates a detailed embodiment of an apparatus 102 for detecting a fibre channel miscabling event. In one embodiment, the apparatus 102 includes the detect module 202, the determine module 204, and the enable module 206 as described in relation to FIG. 2. In another embodiment, the detect module 202 may include a clock synchronization module 302, a word synchronization module 304, and a communicate module 306. The determine module 204 may include a set module 310. Additionally, the apparatus 102 may include a bypass module 308, an error module 312, and a store module 314.

In one embodiment, the clock synchronization module 302 and the word synchronization module 304 synchronize a clock signal and a word transmission respectively. The clock signal may be a periodic optical pulse transmitted at a predetermined frequency. Alternatively, the clock signal may be a periodic shift in potential levels on an electrical line. A word may include a grouping of logical bits represented by optical pulses, potential shifts, and the like. In one embodiment, the clock synchronization module 302 and the word synchronization module 304 synchronize the signals with the use of a phase-locked loop (PLL) circuit. The PLL circuit uses electrical or optical feedback to synchronize an internal signal with the received signal frequency or pattern.

In one embodiment, the communicate module 306 communicates a unique port identifier. Where multiple enclosures exist within a network, and multiple fibre channel cards exist within the enclosures, simply transmitting a port number may be insufficient. Therefore, the communicate module 306 may communicate an enclosure identifier, a card identifier, and a port number.

In one embodiment, the set module 310 sets validity requirements for allowable connection configurations. The validity requirements may be set using a configurable hardware component prior to turning on power to the unit 102, 104. Alternatively, the set module 310 may be used to preset validity requirements during manufacture of the unit 102, 104. In another alternative embodiment, the set module 310 may be used to set validity requirements dynamically or during initial system configuration.

In one embodiment, the bypass module 308 bypasses the fibre channel connection until the fibre channel connection 106 is determined valid and enabled. The bypass module 308 sets the connection to a bypassed state immediately following application of power to the unit 102, 104. The connection 106 is not allowed to communicate data aside from the data required by the detect module 202 and the determine module 204 until the enable module 206 enables the connection 106.

In one embodiment, the error module 312 and the store module 314 indicate an error and store error data, respectively. If a connection 106 is invalid, the error module 312 may indicate an error. In one embodiment, the error indicator may be an illuminated LED on a control panel. Alternatively, the indicator may be a data communication to a user or host. In another embodiment, the error indicator may be a record in an error log. The store module 314 may store information describing the error. In one embodiment, the error module 312 may include the unique identifiers of the ports involved in the invalid connection. Additionally, a time and date stamp, the address of the enclosures involved, and the like may be recorded for later reference by a user or system administrator.

In the case of error or disconnection of cables, the apparatus may detect the reconnection of the fibre channel cable. The detect module 202 detects the connection configuration and the synchronization modules 302, 304 synchronize the clock and word transmissions. The bypass module 308 bypasses the connection upon disconnection of the cable, loss of signal, or loss of clock synchronization. The connection will remain bypassed upon reconnection of the cable or restoration of the signal until the validity of the connection is determined. The determine module 204 determines the validity of the connection, and the enable module 206 enables a valid connection. If the new connection is invalid, the error module 312 indicates an error, and the store module 314 may store error information.

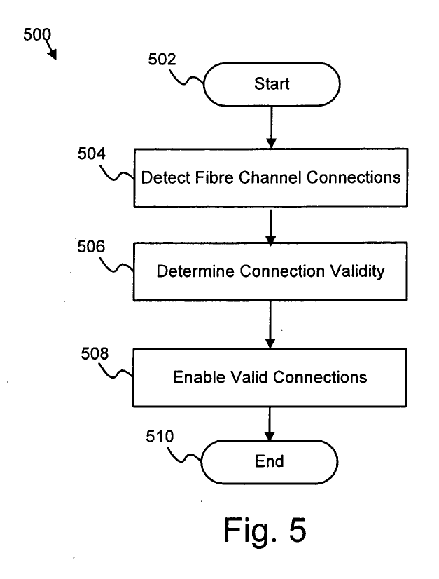

In one embodiment, the second fibre unit 104 may operate in substantially the same way as the first fibre unit 102. The second fibre unit 104 may include the detect module 202, determine module 204, and the enable module 206. These modules, in various embodiments, may be configured to carry out the steps of a method for detecting a fibre channel miscabling event as described further in relation to FIG. 5.

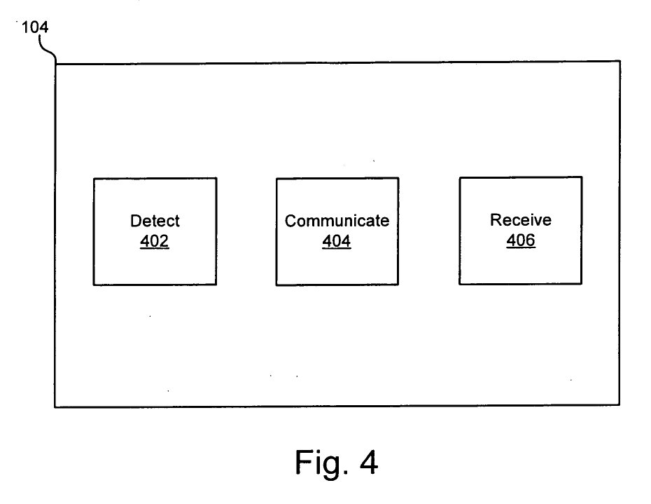

FIG. 4 illustrates an alternative embodiment of an apparatus 104 for detecting a fibre channel miscabling event. The apparatus 104 may include a detect module 402, a communicate module 404, and a receive module 406. The detect module 402 may detect a fibre channel cable connection. In one embodiment, the communicate module 404 communicates a unique port identifier to the first fibre channel unit 102. Additionally, the receive module 406 may receive data on an enabled fibre channel connection.

FIG. 5 is a schematic flow chart diagram illustrating one embodiment of a method 500 for detecting a fibre channel miscabling event. The method 500 starts 502 when the detect module 202 detects 504 a fibre channel cable connection configuration. Then, the determine module 204 determines 506 whether the connection configuration is valid according to preset validity requirements. Finally, the enable module 206 enables 508 a valid fibre channel connection and the method 500 ends 510.

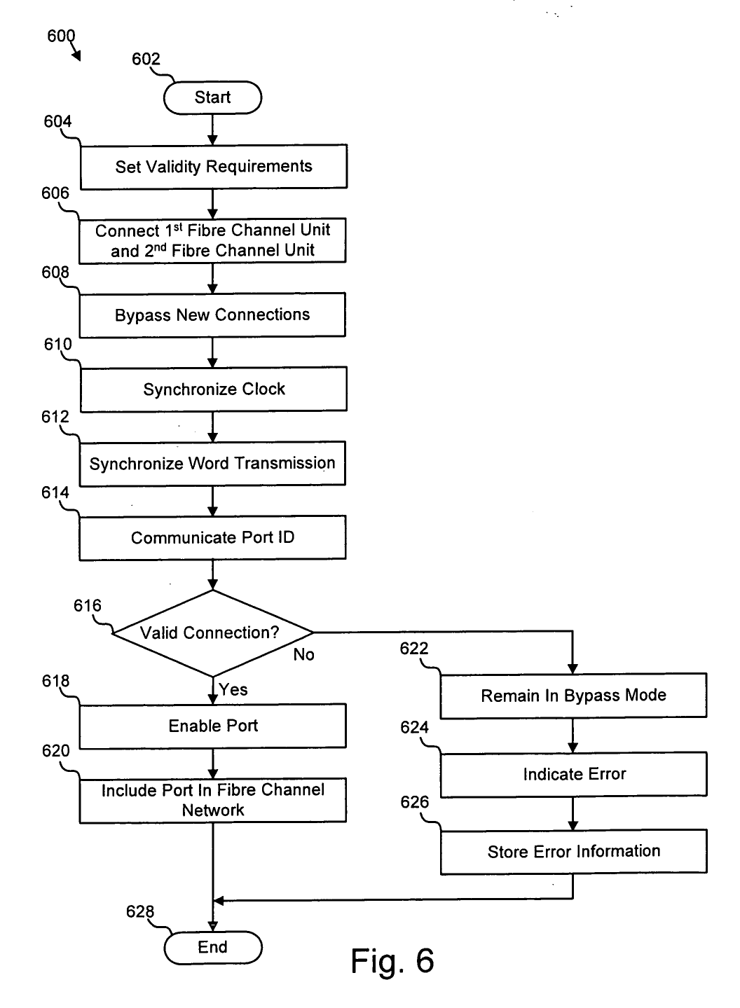

FIG. 6 is a detailed schematic flow chart diagram illustrating one embodiment of a method 600 for detecting a fibre channel miscabling event. In one embodiment, the method 600 starts 602 by setting 604 validity requirements with the set module 310. When the first fibre channel unit 102 and the second fibre channel unit 104 are connected 606, data communication ports on both units 102, 104 are bypassed 608. In one embodiment, bypassing 608 the communication ports is a default function. The clock synchronization module 302 then synchronizes 610 a clock signal. Next, the word synchronization module 304 synchronizes 612 a word transmission, and the communicate module 306 communicates 614 a unique port identifier.

A determination 616 is made whether the connection is valid or not based upon the port identifier and the preset validity requirements. If the connection is 616 valid, the enable module 206 enables 618 the port thereby enabling the data connection, and the port is included 620 in the fibre channel network. If the connection is not 616 valid, the connection remains 622 in bypass mode, an error is indicated 624 by the error module 312, and error data is stored 626 by the store module 314. Once the error information is stored 626 or the connection is enabled 618 and included 620 in the network, the method 600 ends 628.

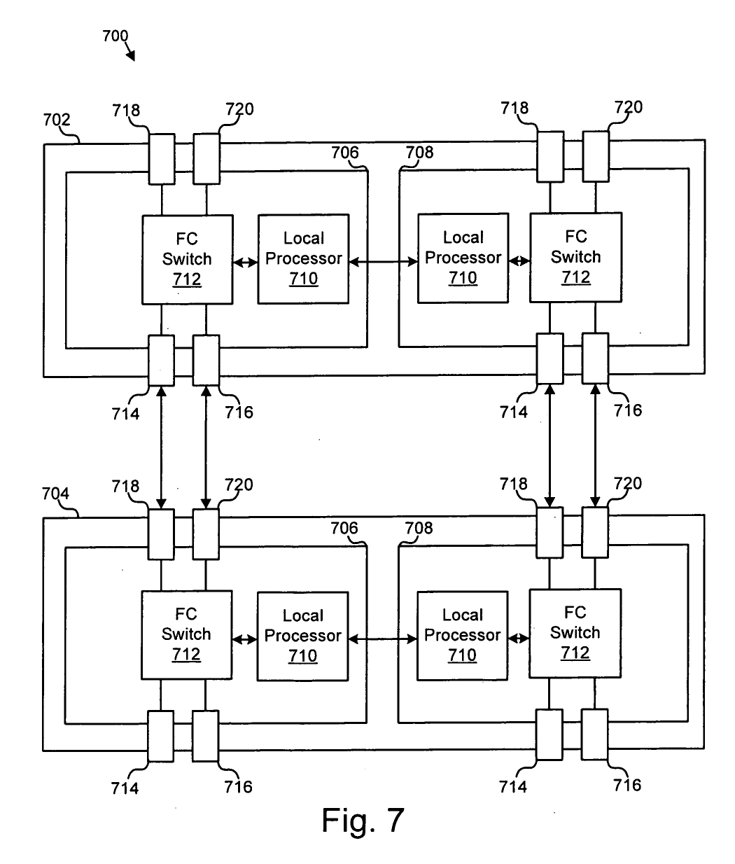

FIG. 7 illustrates one example 700 of a valid fibre channel cable connection configuration. In one embodiment, the system includes a first enclosure 702 and a second enclosure 704. The enclosures 702, 704 include a first fibre channel card 706 and a second fibre channel card 708. The cards 706, 708 include a local processor 710, a fibre channel switch 712, and several ports 714-720. In such an example 700, a user would set the validity requirements between the first enclosure 702 and the second enclosure 704. Allowable connections may include port 714 of the first card 706 of the first enclosure 702 to port 718 of the first card 706 of the second enclosure 704. Other similar connections between ports 716 and 720 on the first fibre channel card 706 and the second fibre channel card 708 of the first enclosure 702 and the second enclosure 704 may also exist.

In another example, a third enclosure may be added to interface with the second enclosure 704. In such an example, the port 714 of the first card 706 of the second enclosure 704 to port 718 of the first card 706 of the third enclosure, and so on.

In addition to connecting successive enclosures together containing switches 712 and local processors 710, some modular storage systems include enclosures that contain unlike components, such as an enclosure containing an initiator as opposed to an enclosure containing a switch 712. For purposes of the present application, connections between like components or devices are illustrated in an example in previously described FIG. 7. As previously discussed, the preset validity requirements are used to ensure a properly configured topology. Again, for modular storage enclosures that contain like components, technology such as that previously described can be implemented that allows informational exchanges to occur between the like components and detects proper cabling.

For enclosures that are connected to unlike components, such as a Fibre Channel-Arbitrated Loop (FC-AL) initiator instead of an FC-AL switch in a modular storage enclosure, the opportunity for informational exchange can be compromised. To minimize the opportunity for incorrect cabling to impact FC-AL operation, the preset validity requirements or similar cabling rules can implement a low level port enablement policy which accounts for the cases where unlike components are cabled into a configuration. The low level port enablement policy includes a default rule that modular enclosure upstream ports are the only ports allowed to be connected to FC-AL initiators or unlike components. In addition, in the case of downstream ports, for any case where an unlike connection is detected, the local processor will not enable the downstream ports. Such a default rule can remove fifty (50) percent of possible cabling error configurations.

In an operation similar to that previously discussed, the fibre channel switch devices can perform a topology exploration to discover whether or not the switch devices are connected to a like fibre channel switch device. If there is an unlike device (e.g., not a fibre channel switch) then the local processor must make a decision on enabling the associated ports without specific knowledge of the rest of the topology. If the fibre channel switch device finds that the switch is connected to a like switch device, a bi-directional transfer of information occurs between the two switch devices. The data payload of the information transfer is an implementation-unique definable structure. Part of the data payload is the unique port identifier discussed previously. The local processor utilizes the data transfer (or lack thereof in the case of an unlike device) to determine if the associated ports should be enabled or not.

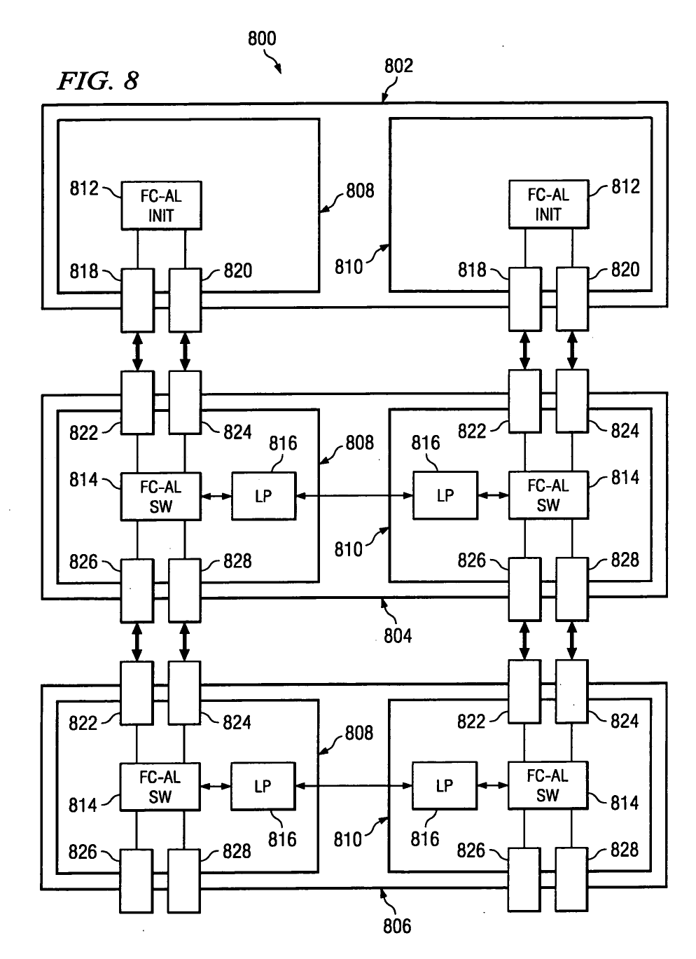

Turning to FIG. 8, an example legal FC-AL topology 800 is depicted. The system includes a first enclosure 802, a second enclosure 804 and a third enclosure 806. The enclosures 802, 804 and 806 include a first fibre channel card 808 and a second fibre channel card 810. The cards 808, 810 as part of enclosures 804 and 806 include fibre channel switches 814 and local processors 816. Cards 808, 810 as part of enclosure 802 do not contain switches 814 or local processors 816. Instead, fibre channel initiators 812 are enclosed. Because enclosure 802 contains initiator 812 as opposed to switch 814 and local processor 816, enclosure 802 and 804 are unlike devices.

A user can set the validity requirements between the first enclosure 802, the second enclosure 804 and the third enclosure 806. Allowable connections include the upstream ports 822 and 824 of the head of string storage enclosure 804 connected to the controller enclosure 802. In addition, subsequent cascaded enclosures (e.g., enclosure 806) from enclosure 804 are connected with proper like device to like device (switch 814 to switch 814). As such, downstream ports 826 and 828 of enclosure 804 are connected to upstream ports 822 and 824 of enclosure 806.

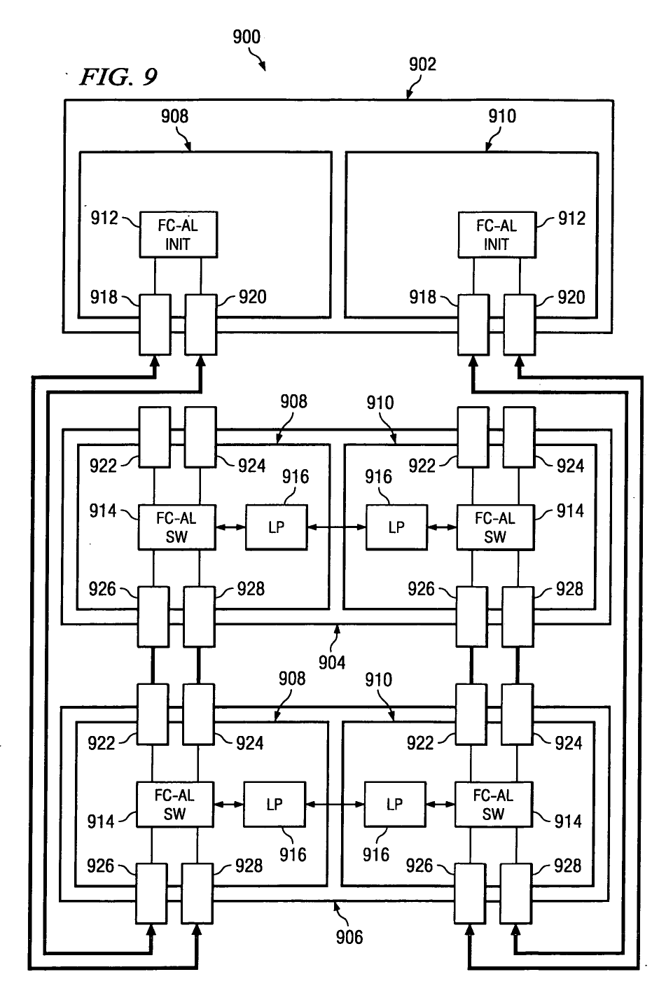

FIG. 9 shows an example of an improperly connected topology 900 of modular storage enclosures. Controller enclosure 902, 904 and 906 include a first fibre channel card 908 and a second fibre channel card 910. The cards 908, 910 as part of enclosures 904 and 906 include fibre channel switches 914 and local processors 916. Cards 908, 910 as part of enclosure 902 do not contain switches 914 or local processors 916. Instead, fibre channel initiators 912 are enclosed. Here as in FIG. 8, because enclosure 902 contains initiator 912 as opposed to switch 914 and local processor 916, enclosure 902 and 904 are unlike devices. In the present example, ports 918 and 920 of initiators 912 are directly cabled to the downstream ports 926 and 928 of enclosure 906. The depicted miscabling condition is detected by the local processors 916 housed in enclosure 906. The miscabling condition is detected by the fact that no information transfer transactions occurred between enclosure 906, card 908, ports 926 and 928 and enclosure 906, card 910, ports 926 and 928 and the ports attempting to connect with the switches 914. In the depicted condition, the local processors 916 of enclosure 906, card 908 and card 910 will not enable enclosure 904, card 908, ports 926 and 928 and enclosure 904, card 910, ports 926 and 928. Additionally, an error message regarding the attempted connection will be generated and/or a local fault indicator that the connection is incorrect will be provided to the user.

In addition to a situation where a series of like enclosures are properly cascaded from an unlike enclosure as shown in FIG. 8 in a single system, multiple systems of storage enclosures can be located in close proximity to each other. The close proximity of storage systems creates an opportunity where two systems can be inadvertently cross-connected. For example, the downstream ports of an unlike device in a first system can be inadvertently connected to the upstream ports of an unlike device in a second system. By using the above-described default rule, a policy on port enablement is realized such that the ports that are miscabled will never be enabled, thus eliminating a loss of access customer impact or similar negative exposure.

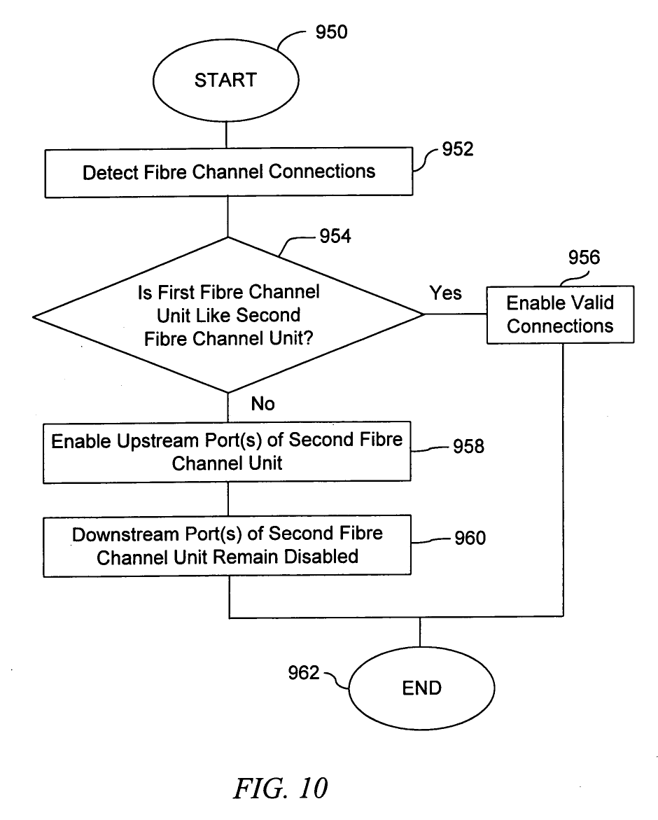

FIG. 10 illustrates a schematic flow chart diagram illustrating one embodiment of a method for detecting a fibre channel miscabling event using the previously described default rule. The method starts 950 when the detect module 202 detects 952 a fibre channel cable connection configuration. The determine module 204 next queries 954 whether the a first fibre channel unit is like a second fibre channel unit, for example, by making a determination of whether an information transfer transaction occurs between the first and second units as previously described. If the result of the query is negative (i.e., the system determines that two unlike devices are connected), the enable module 206 enables 958 the upstream ports of the second fibre channel unit while keeping 960 the downstream ports of the second fibre channel unit disabled. If the result query 954 is positive (i.e., the system makes a determination that two like devices are connected), then the system may proceed to enable valid connections in a manner similar to that described in FIGS. 5 and 6. For example, determine module 204 determines whether the connection configuration is valid according to remaining preset validity requirements. The enable module 206 then enables 956 a valid fibre channel connection according to the remaining preset validity requirements and the method ends 962.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus to detect a fibre channel miscabling event, comprising:
a module configured to identify a connection made between first and second unlike devices in a fibre channel topology, wherein if an unlike connection is made the module enables an upstream port of the second device, leaving a downstream port of the second device disabled.

2. The apparatus of claim 1, wherein the module is configured to detect a fibre channel cable connection configuration, determine whether the connection configuration is valid according to preset validity requirements and enable a valid fibre channel connection.

3. The apparatus of claim 1, wherein the module is further configured to synchronize a clock signal, synchronize a word transmission and communicate a unique port identifier.

4. The apparatus of claim 3, wherein the unique port identifier further comprises an enclosure identifier, a card identifier, and a port identifier.

5. The apparatus of claim 1, wherein the module is further configured to bypass the fibre channel connection until the fibre channel connection is determined valid and enabled.

6. The apparatus of claim 1, wherein the module is further configured to set validity requirements for allowable connection configurations.

7. The apparatus of claim 1, wherein the module is further configured to indicate an error when a connection configuration is determined invalid.

8. The apparatus of claim 1, wherein the module is further configured to store error information when a connection configuration is determined invalid.

9. A signal bearing medium tangibly embodying a program of machine-readable instructions executable by a digital processing apparatus to perform operations to detect a fibre channel miscabling event, the operations comprising:
detecting a fibre channel cable connection configuration;
determining whether a connection is made between first and second unlike fibre channel units; and
enabling an upstream port of the second fibre channel unit while keeping a downstream port of the second fibre channel unit disabled if an unlike connection is determined to have been made.

10. The signal bearing medium of claim 9, wherein the operation to detect a connection configuration further comprise operations to:
synchronize a clock signal;
synchronize a word transmission; and
communicate a unique port identifier.

11. The signal bearing medium of claim 10, wherein the unique port identifier further comprises an enclosure identifier, a card identifier, and a port identifier.

12. The signal bearing medium of claim 9, wherein the instructions further comprise an operation to determine whether the connection configuration is valid according to preset validity requirements and enable a valid fibre channel connection if a like connection is determined to have been made.

13. The signal bearing medium of claim 12, wherein the instructions further comprise an operation to bypass the fibre channel connection until the fibre channel connection is determined valid and enabled.

14. The signal bearing medium of claim 12, wherein the operation to determine further comprises setting validity requirements for allowable connection configurations.

15. The signal bearing medium of claim 12, wherein the instructions further comprise an operation to indicate an error when a connection configuration is determined invalid.

16. The signal bearing medium of claim 12, wherein the instructions further comprise an operation to store error information when a connection configuration is determined invalid.

17. A method to detect a fibre channel miscabling event, the method comprising:
detecting a fibre channel cable connection configuration;
determining whether a connection is made between first and second unlike fibre channel units; and
enabling an upstream port of the second fibre channel unit while keeping a downstream port of the second fibre channel unit disabled if an unlike connection is determined to have been made.

18. The method of claim 17, further including determining whether the connection configuration is valid according to preset validity requirements and enable a valid fibre channel connection if a like connection is determined to have been made.

19. The method of claim 17, wherein detecting a connection configuration further comprises:
synchronizing a clock signal;
synchronizing a word transmission; and
communicating a unique port identifier.

20. The method of claim 19, wherein the unique port identifier further comprises an enclosure identifier, a card identifier, and a port identifier.
